(19) United States
(12) Patent Application Publication
(10) Pub. No.: US 2015/0048016 A1
(43) Pub. Date: Feb. 19, 2015

(54) FILTERING DEVICE FOR THE LARGE-AREA FILTRATION OF FLUIDS

(71) Applicants: Frank Hartmann, Steinfurt (DE); Christian Schroder, Munster (DE)

(72) Inventors: Frank Hartmann, Steinfurt (DE); Christian Schroder, Munster (DE)

(73) Assignee: Nordson Holdings S.a.r.l. & Co. KG, Erkrath (DE)

(21) Appl. No.: 14/372,987

(22) PCT Filed: Jan. 26, 2013
(86) PCT No.: PCT/EP2013/051521

§ 371 Date: Oct. 30, 2014

(30) Foreign Application Priority Data
Jan. 26, 2012 (DE) 10 2012 100 641.5

(51) Int. Cl. B01D 29/96; B01D 29/66; B01D 29/52

(52) U.S. Cl. CPC B01D 29/96; B01D 29/52; B01D 29/66
USPC 210/232

(57) ABSTRACT

A filtering device (100′) for the large-area filtration of polymer melts comprises at least: a housing (20; 20′) with at least one inlet channel (23; 71′) and at least one outlet channel (26; 61′) and a filter carrier element (40, 40′), which can be moved longitudinally in relation to a housing bore and has at least one filter insert (10; 10′), which in a production position can be arranged in a filter chamber (24; 24′) between the inlet channel (23; 71′) and the outlet channel (26; 61′) of the housing (20; 20′), wherein the filter insert (10, 10′) has a main element (12, 12′) through which the flow can pass, and from which a fluid stream branches off to multiple individual filter elements (11, 11′) or in which multiple fluid streams from the individual filter elements are combined. The filter insert (10, 10′) is arranged on an end face of the filter carrier element (40, 40′). The filter chamber (24, 24) is formed by a housing bore, which extends up to a mouth (25) on an outer side of the housing and into which the filter insert (10, 10′) can be pushed by moving the filter carrier element (40, 40′), and a closure element (41, 41′), which can be placed onto the mouth (25) of the housing bore and/or can be inserted therein when the filter carrier element (40, 40′) is lowered into the housing bore or thereafter.

The invention relates to a filtering device for the large-area filtration of fluids, which consists of at least:
a housing with at least one inlet channel and at least one outlet channel and
a filter carrier element which can be moved longitudinally in relation to a housing bore consisting of at least one filter insert, which is to be allocated in a filter chamber that is located between the inlet channel and the outlet channel of the housing in a production position,
wherein the filter insert has a main element through which the flow can pass, and from which a fluid stream branches off into multiple individual filter elements or into which multiple fluid streams from the individual filter elements are joined.

In filtering devices of the mentioned kind, polymer melts flow through a filter insert element which is located inside of a cylindrical filtering housing, which is constructed as a large-area filter in form of a disc- or cartridge filter, at temperatures reaching up to 350° C. and with pressures reaching up to 300 bar.

Such large-area filters in form of double filters are know from DE-C-19823765 or DE-A-102005061770. In these embodiments, each individual filter with its cylinder tube shaped filter housing can be swung out of its working position, in order to pull out the filter inserts upwards for a filter replacement. In these embodiments, both filters are mounted to a carrying die set or are solidly interconnected via the switching valves. The filter housings are interconnected via the valves or a carrying die set. Therefore, a replacement or a cleaning of the filter insert is difficult, since the temperature of the filter housing as well as of the remaining device cannot be maintained.

When polymer melts are filtered, the high processing temperatures lead to significant thermal expansions within the filter elements. By means of this, pressures and displacements occur within the modular embodiment of suchlike double filters with the danger of leakage at the junctions of the flow channels in various elements. This basic problem cannot be solved with the solution suggested in DE-A-102005061770, because it is important that there always is a heated filter insert for a filter change, which consists of the same temperature as that of the housing. If this is not the case, it will not be possible to perfectly align the flow channel junctions of the filter insert to the flow channels of the housing and to connect them in a way that they are fully sealed, due to the thermal expansion.

Thus, the present invention has the objective to produce a filtering device for the large-area filtration of polymer melts in particular, which can be cleaned easily and where a filter insert can be replaced in a quick and safe manner. The filtering device further has to consist of a construction which can be homogeneously heated, in order to prevent mounting- and leakage problems due to different thermal expansions.

The objectives are accomplished by means of a filtering device for the large-area filtration of fluids, in particular of polymer melts, by means of the characteristics of claim 1.

It is fundamental that the filtering device consists of at least one drive unit and a solid filter housing with a filter chamber, whereby the filter insert can be inserted into a bore of the housing by means of a translational movement, and where a closure element on the filter insert seals the bore hole, by means of which a fully sealed filter chamber is formed.

By means of the drive unit, a simple maintenance and cleaning of the filter insert is possible. In this way, the filter insert can be installed and removed, and the filter chamber can be cleaned without having to reduce the temperature in the solid housing.

The temperature of the housing is preferably homogeneously controllable. In a preferred embodiment, heating-cooling channels for a homogeneous heating are intended in the solid housing. The heating can be accomplished in a hydraulic- or electric way as well as by means of a steam heating.

The filtering device according to the invention is preferably suited for polymer melts, e.g. for polyester, polyether or polyamide.

The filtering device according to the invention is suited for melts within a temperature range of up to 350° C., preferably from 10° C. to 350° C., preferred from 10° C. to 300° C.

In a preferred embodiment, the invention consists of switching valves that can be screwed onto the filtering housing or that can be built into the housing, by means of which the flow of the melt to the filter via the flow channel junctions can be released or stopped. They are aligned to the respective inlet- or outlet channel.

In a preferred embodiment, the valves are designed in such a way, that the filter insert can be cleaned by means of a backflush function with a flow reversal in the filter insert. For this reason, backflush channels are arranged in the switching valve and in the housing, by means of which the filter cake can be discharged from the filter medium towards the outside.

The filtering device according to the invention can be used in a continuous as well as in a discontinuous operating mode.

In a first preferred embodiment, the filtering device can work as a simple, discontinuously operating filter, in that the filter housing is designed as a solid housing with only one filter chamber for one single filter insert as well as with an attached drive unit for a simple filter replacement. This construction form allows for a construction without the use of valves for stopping or releasing the melt flow through the filter, as long as the device can be turned off for the filter replacement.

In a further preferred embodiment, the filtering device can be made in form of a continuously operating multiple filter, in particular in form of a double filter, and can consist of a simple, solid construction that can be heated very homogeneously, in order to prevent mounting- and leakage problems due to differing thermal expansions.

In a preferred embodiment, such a double filter is operated in a parallel arrangement of two filter inserts, in order to be able to operate without any production interruption while one filter insert is being replaced.

In a further embodiment, a parallel arrangement of two or more filters is possible as well, in order to e.g. accomplish a stage filtering, in which there is a coarse filtering in a first filter insert and a fine filtering in a second filtering insert.

The construction type of such double- and multiple filters is a subsequent arrangement of filtering devices according to the invention in the previously mentioned basic way of construction, but which consist of a common housing.

The multiple filtering devices preferably consist of switching valves, which enable a distribution of the fluid flows according to the desired operation mode.

A double filter can be operated as a continuous filtering system in two different functions with two filtering inserts that are arranged parallel:

On the one hand it is basically possible that both filter inserts are used for the filtration during production. If these have to be replaced after a certain time due to dirt in the filter elements, one filter insert is first disconnected from the inflow and outflow of the melt by means of the valves, while the other one is kept in production. In this way the first filter insert can be replaced without any production interruption. After the filter replacement is accomplished, the new filter insert is put into production by means of the valves, the second used insert is disconnected from the production in the same way, in order that it can be replaced as well. After both filter elements have been replaced, the production can again be performed by means of both filter inserts.

On the other hand, it is possible that only one of the filter inserts of a double filtering device is used for the filtration. The second filter insert is in a waiting position in the second filter chamber without being used. As soon as the filter insert that is in production is soiled and has to be replaced, it is possible to switch to the second filter insert of the double filtering device which is in a waiting position, ready for use, by means of the valves.

Since the housings of a discontinuously operating single filter as well as of a continuously operating multiple filter, in particularly of a double filter, are designed in a solid way and are equipped with a suitable heating for a permanent homogeneous temperature control during the filtering of polymer melts, a replacement of the filter inserts can be performed at any time. Thus, there are no waiting periods for heating up certain parts of the housing, in order that they can be subsequently interconnected in a precise manner.

The removal or replacement of a filter insert can be arranged in a very simple way, since it is only necessary that the filter carrier element with the filter insert is moved out of the housing by means of a drive unit, e.g. a hydraulic cylinder.

The axes of the filter carrier element, of the filter insert that is attached to it and of the filter chamber, are preferably aligned in the same direction. The operation of the drive unit thus allows for a removal of the filter insert without having to produce any transverse forces for it, since the drag force issues in longitudinal direction of the filter insert. In known large-area filters on the other hand, filter inserts are general lifted out of the housing by means of a crane, which leads to forces that issue in a slanting way which may include the danger of damage to the filter insert.

It is further possible that the motion of the filter carrier element is used in order to clean the filter chamber of the melt. In order to accomplish this, cleaning scrapers, brushes or other possible cleaning tools can be attached to the drive unit and can be moved up and down with it inside the filter chamber. This allows the operating personnel to clean the bore in a simple, efficient and safe way, since it can be performed inside the hot housing by the machine.

The function of the valves, which can advantageously be mounted to a multiple filter, e.g. to a double filter or which can be integrated into the solid housing in a different construction type, is to release the melt inlet or outlet of the one of the other filter chamber of the housing, whichever is selected. In a middle position of the valve, the flow of the material can be directed via both filter chambers of the housing.

A special form of the switching valve can be intended to perform a backflush function for a self-cleaning of the filtering device by means of additional channels inside the valve pistons and inside the housing. In order to accomplish this, the inlet valve is set in a position, where the inflow of the material into the filter chamber, that is to be backflushed, is interrupted. Instead, the backflush channel within the inlet valve is set in a hydraulic connection with this filter chamber while at the same time the connection to the outlet channel on the outlet side is maintained. By means of this, a flow reversal is accomplished inside the filter chamber that is to be backflushed, where the melt is flowing from the clean side of the filter insert through the filter medium towards the dirt side of the filter insert, where it lifts the filter cake off the filter medium and discharges it via the backflush channel in the inlet valve toward the outside of the housing.

The same backflush procedure can advantageously be designed in such a way, that a backflush channel is directly inserted into the filter chamber, which can be sealed with a plug or a simple stop valve, instead of a backflush channel inside the inlet valve. In order to perform a backflush, the inflow to the filter chamber has to be stopped by means of such a simple inlet valve and the flow connection on the outlet side has to be maintained. An opening of the backflush channel of the filter chamber by means of a removal of the plug or by means of opening the simple valve accomplishes the flow reversal inside the filter chamber along with the cleaning effect of the filter medium.

The flowing direction of the filtering device according to the invention is solely determined by the kind of filter insert. Stacked disc filters are usually flown through from the outside towards the inside, in order to prevent an expansion resulting from the existing high pressure. Apart from that, the mentioned flowing directions of the embodiments which are described in the following are also reversible.

In the following, the invention is further described with reference to the depictions. The figures depict in detail:

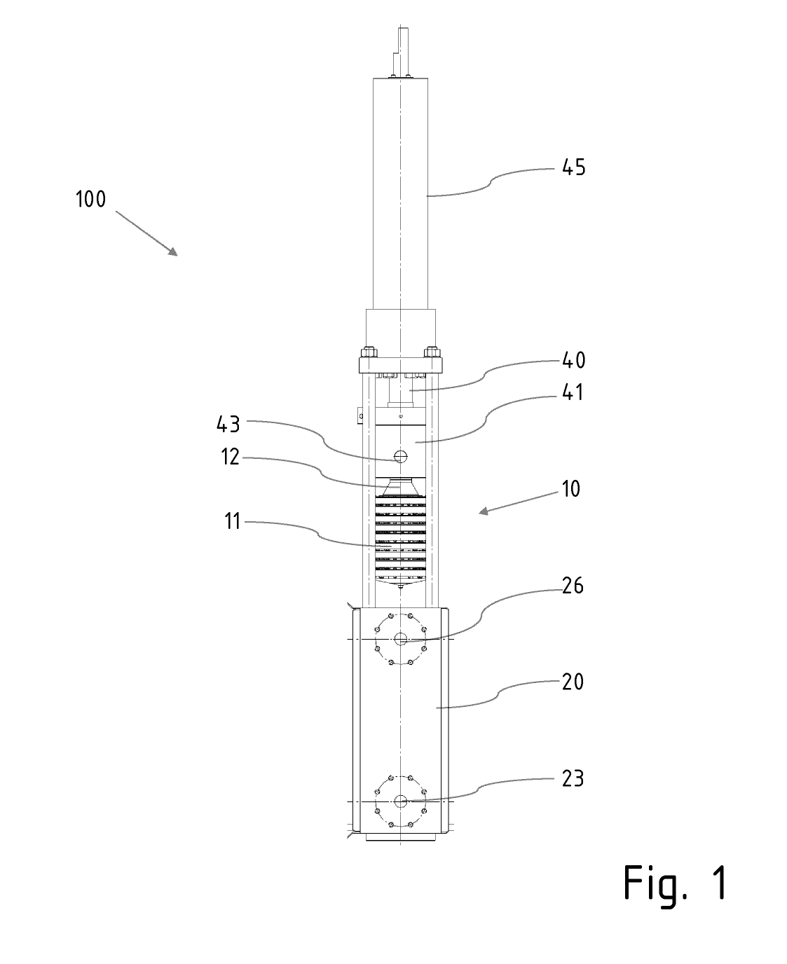

FIG. 1 a front view of a simple, discontinuously operating large-area filtering device with pulled out filter insert;

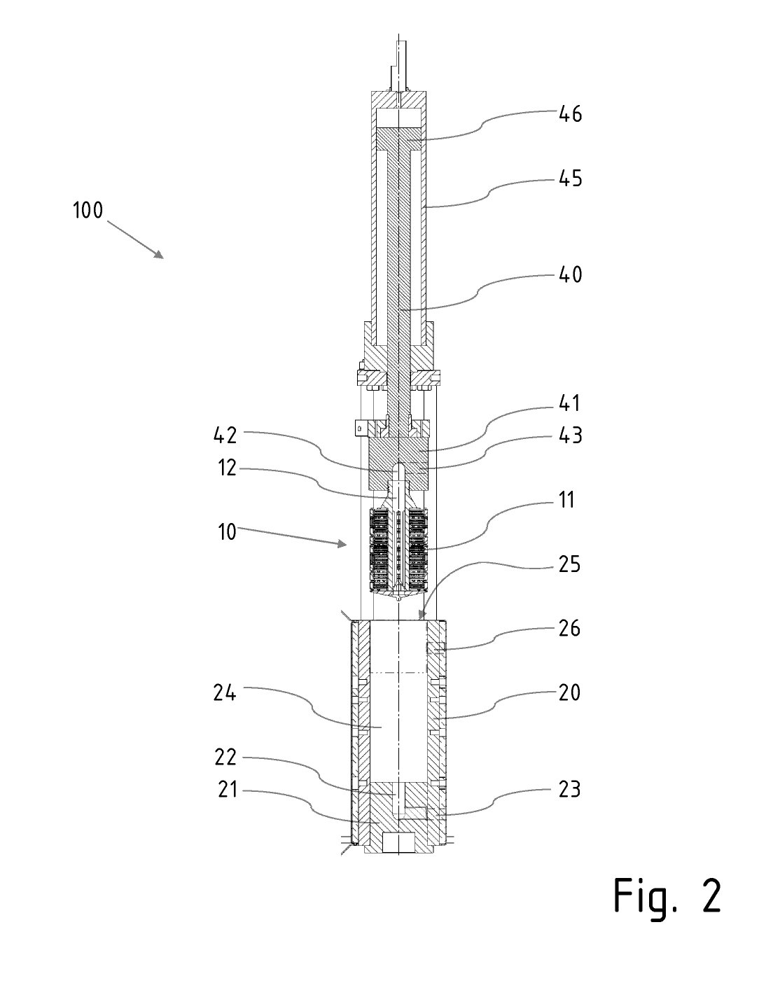

FIG. 2 a vertical section through the filtering device according to FIG. 1;

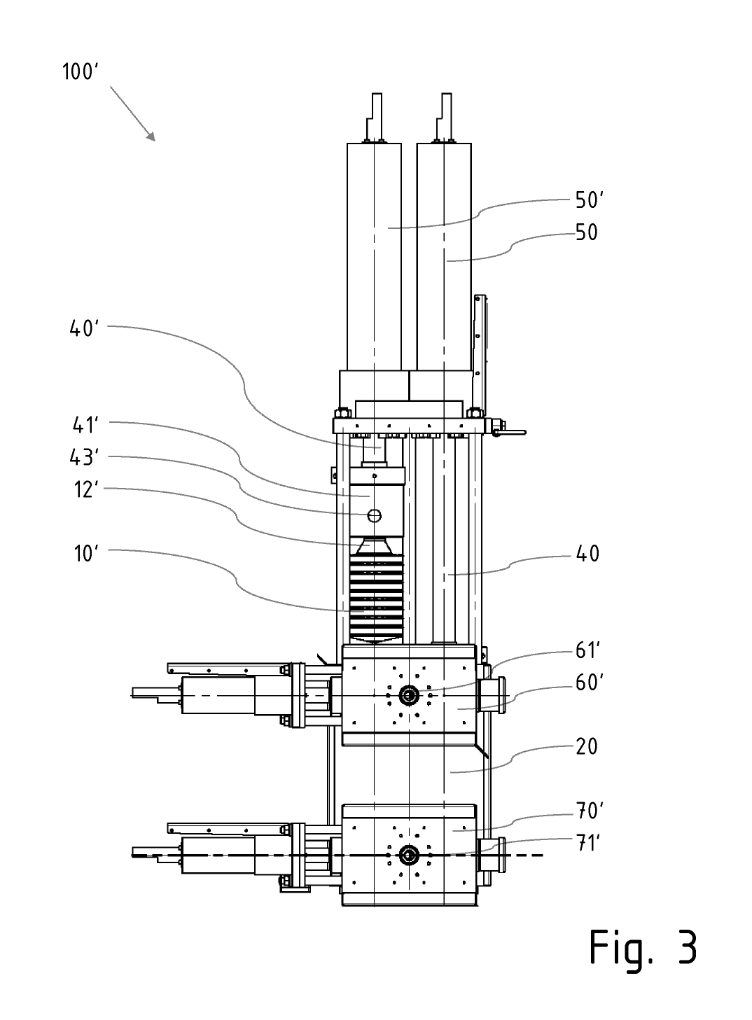

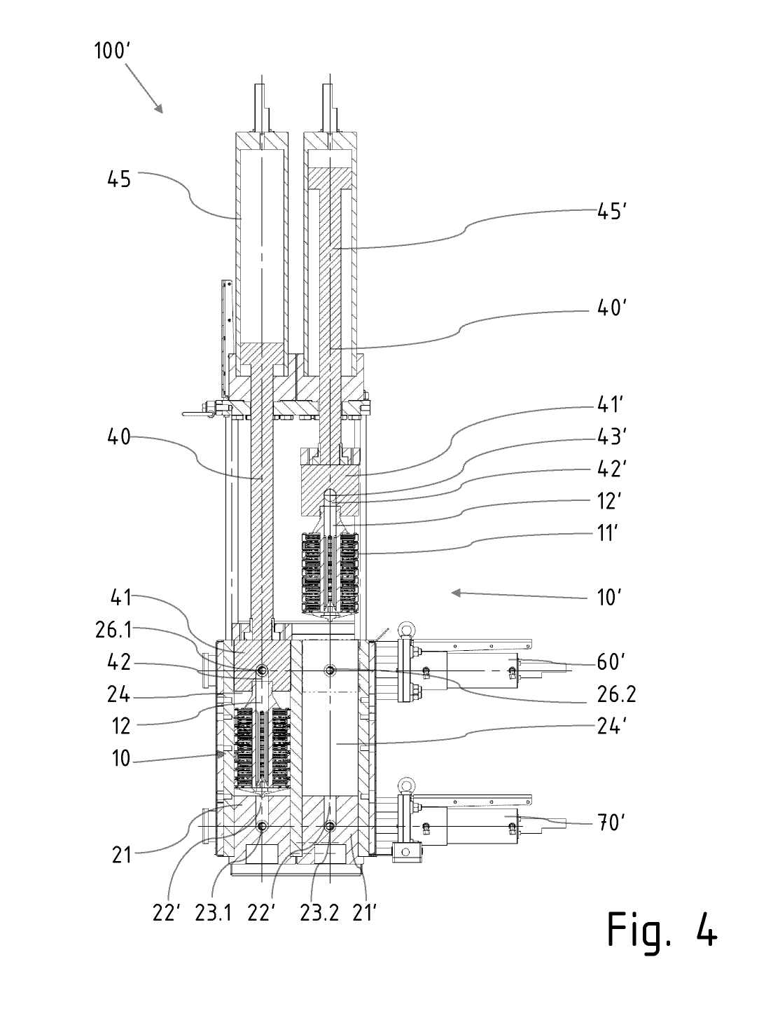

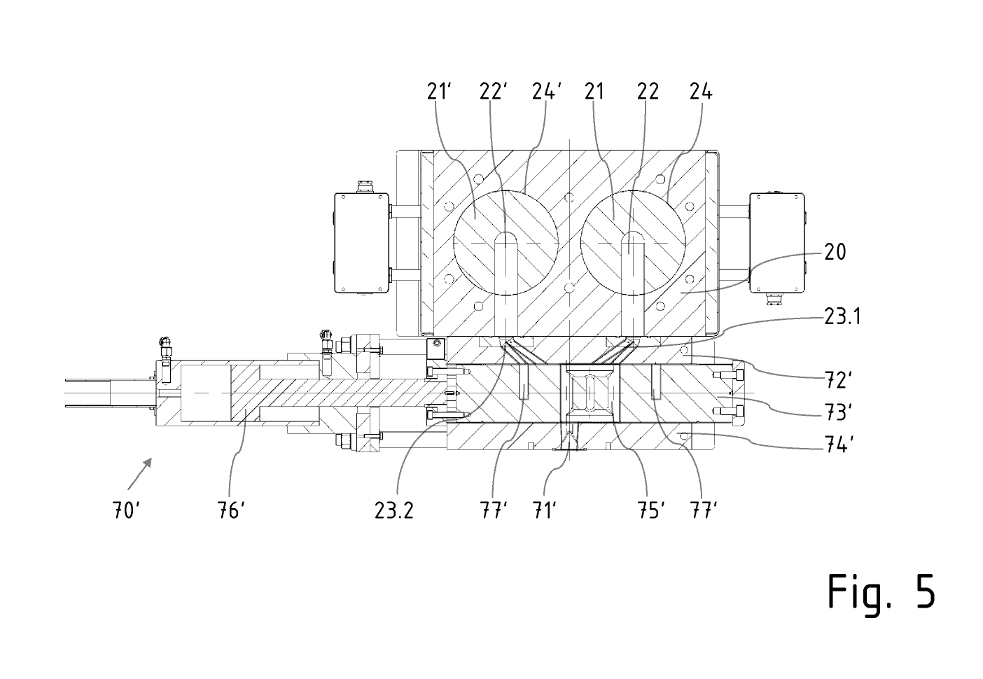

FIG. 3 a front view of a double filtering device;

FIG. 4 a vertical section of the double filtering device according to FIG. 3;

FIG. 5 a vertical section through the housing, filter insert and switching valve;

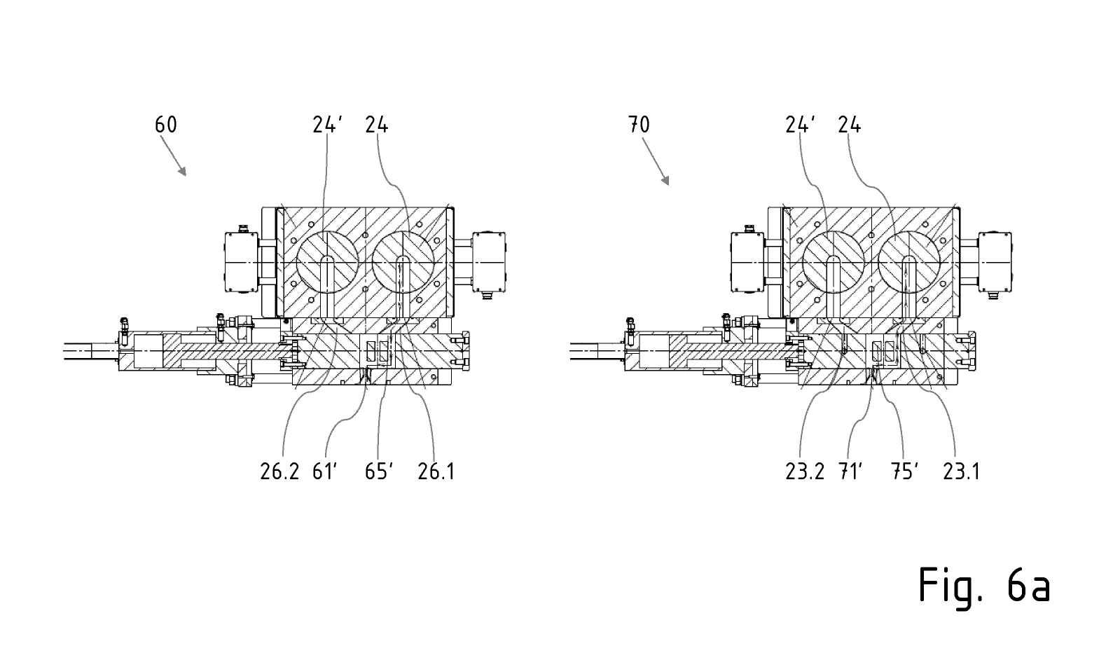

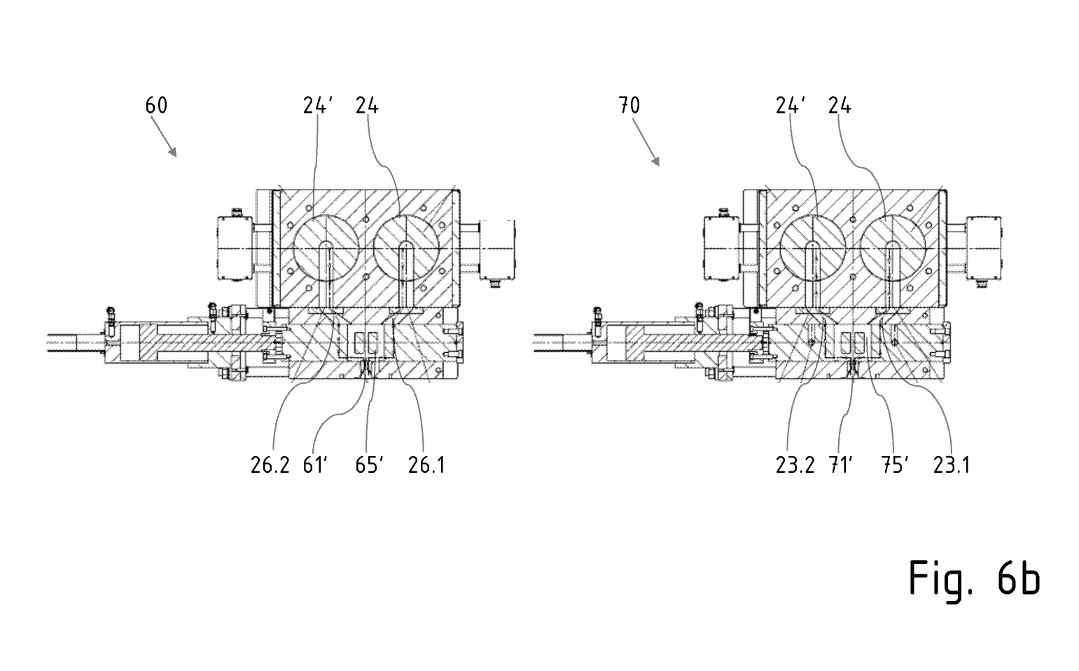

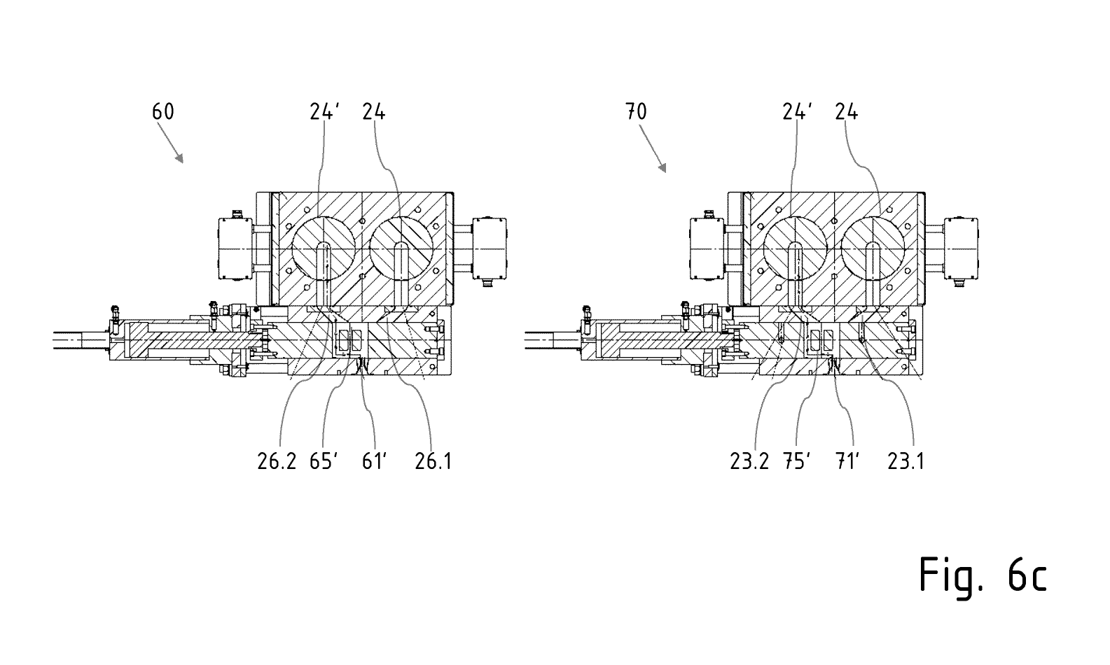

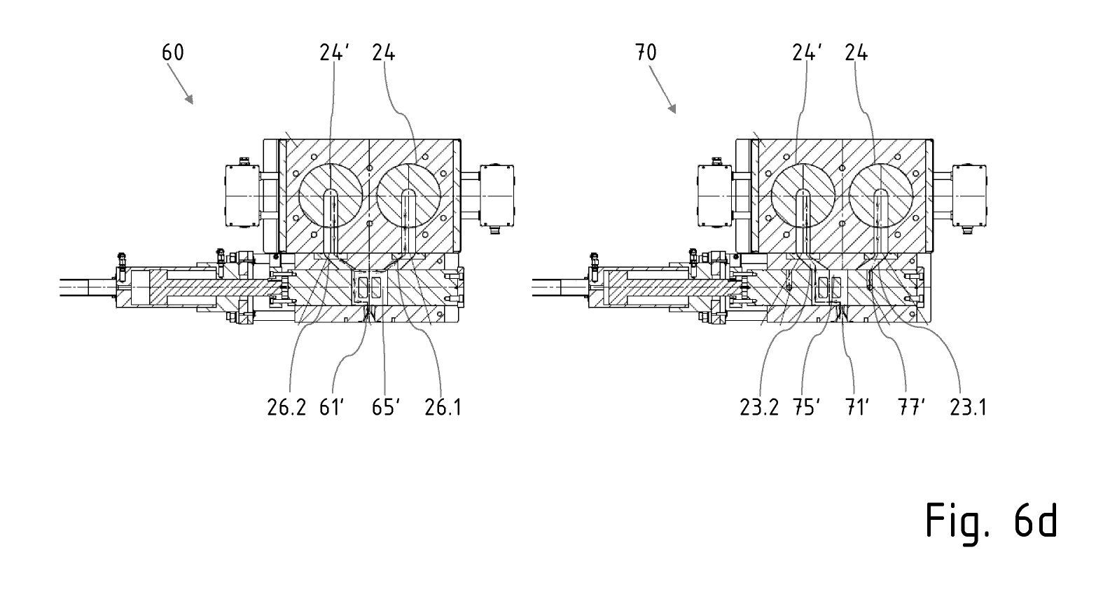

FIGS. 6a-6d a respective horizontal section through the housing and outlet valve next to a section through the housing and the inlet valve in different operating modes of the double filtering device.

A simple filtering device 100 according to the invention, which is operated discontinuously, is depicted in FIG. 1.

It features a filtering housing 20 with one inlet channel 23, one outlet channel 26 and a filter chamber that is located on the inside. Heating-cooling channels are arranged within housing 20 for holding electric heating cartridges, in order to achieve a homogeneous temperature control of the overall housing 20.

An attached drive unit 45 consists of a hydraulically operated cylinder, by means of which a filter carrier element 40 can be axially moved.

In the depicted embodiment, filter carrier element 40 consists of a filter insert 10, which is attached to its lower end face, which is created like a pyramid cake with a support profile 12 that is flown through centrally and a plurality of disc filter elements 11, so called leaf-disc-filter element, which are stacked on top of it. The individual disc filter elements 11 consist of a respective encasements that are made of a metal filter fabric, which is spanned by means of a support frame, so that a hollow space is created. The fluid that has passed the filter fabric, flows out of the spanned hollow space into the central support profile 12, as it is generally know.

Essential for the invention is, that above filter insert 10, there is a closure element 41 which is attached onto filter carrier element 40. It consists of a radial flow channel 43, which is directed downwards and which leads into support profile 12 of the filter insert.

FIG. 2 depicts the same filtering device 100 in cross section. The design of drive unit 45 is clearly detectable in the upper section. The upper end of filter carrier element 40 is designed as piston 46.

Also detectable in FIG. 2 are the paths of the flow inside of closure element 41 with an axial flow channel 42 and a radial flow channel 43, which overlaps with outlet channel 26 on the housing side when filter insert 10 is pushed into filter chamber 24. The position of closure element 41 in production position is suggested by the dotdashed rectangle.

Filter chamber 24 is created by means of a bore in housing 20, which first of all, has to be produced all the way through, due to technical reasons, and which was then tightly sealed by means of insert element 21. An axial flow channel 22 within the closure element is in connection with inlet channel 23 of housing 20 and leads into filter chamber 24.

The mouth 25 of the housing bore or of filter chamber 24 toward the upper side is open, when filter insert 10 is pulled out.

It is further essential for the invention, that support profile 12 of filter insert 10 is arranged in a parallel way towards the center axis of filter carrier element 40 and towards its sliding direction, in particular that they are aligned in the same direction.

Filter carrier element 40 with filter insert 10 are lowered into filter chamber 24 along with closure element 41, so that closure element 41 tightly seals mouth 25 of the bore that is open on the upper side and thus a closed filter chamber 24 is formed.

In production position, filter insert 10 is located inside of filter chamber 24 and can be freely flown through. The fluid reaches through the filter fabric of the individual disc filter elements 11, from there into the central support profile 12 and then, via flow channels 42, 43 to the outlet channel 26 in housing 20.

After the production has ended, or when a replacement of filter insert 10 is necessary, filter carrier element 40 with the closure element 41 and filter insert 10 is again pulled out of filter chamber 24, so that its mouth 25 is open again. In the pulled out state, as depicted in FIGS. 1 and 2, filter insert 10 is freely accessible and can be replaced or serviced.

Instead of filter insert 10, a mechanical cleaning element, like a scraper or a wire brush, can be attached to filter carrier element 40 as well, in order to enable a cleaning of the filter chamber.

FIG. 3 depicts a double filtering device 100′, which basically consists of two partial filtering devices 100 according to the embodiment that has been described with reference to FIGS. 1 and 2, whereby these are here connected by means on a common housing 20′.

Filter carrier elements 40, 40′ of double filtering device 100′ can be moved individually, so that e.g. one of the filter inserts 10′ can be moved out of filter chamber 24′, while the other one remains in production operation.

In order to perform the distribution of the fluids to the individual partial filtering devices, the double filtering device 100′ consists of additional switching valves 60′, 70′.

The lower switching valve 70′ is used to distribute the fluid that is supplied at inlet channel 71′ to the respective filter chambers. At switching valve 60′, the individual flow paths from the filter chambers to an outlet channel 61′ can also be closed in such a way, that one filter chamber can remain open while the other one is used for the production operation.

The exact function of the filtering device 100′ results from the sectional view according to FIG. 4:

The left partial filtering device is depicted here in production operation. Filter insert 10 is lowered into filter chamber 24. Closure element 41 at filter carrier element 40 closes the upper section of the left bore in housing 20′, by means of which a sealed filter chamber 24 is formed.

The fluid enters through an inlet sub-channel 23.1, which is fed via switching valve 70′, into flow channel 22 and into filter chamber 24, which is located above it. There, it enters through the individual disc filter elements 11 of filter insert 10 into the central support profile 12 and via flow channel 42 inside of closure element 41 into outlet channel 26.1.

The right partial filtering device is set in waiting position. Filter chamber 24′ is open at the top. Appropriate switching positions at switching valves 60′, 70′ ensure that no melt or any other filtered fluid can leak out of filter chamber 24′ at the inlet- and outlet channels 23.2, 26.2.

FIG. 5 depicts a section through the lower switching valve 70′ for the incoming stream and the flow channels in the base of filtering device 100′.

In the upper part of FIG. 5, the base area of housing 20 is cut. The round elements are the closure elements 21, 21′ (compare FIG. 4), which allow that filter chambers 24, 24′ are created by one respective bore all the way through housing 20′ in a simple way and then to seal the one end permanently by means of the inserted closure elements 21, 21′.

The actual switching valve 70′ consists of two parallel plates 72′, 74′ and a slider element 73′ which is located in between, and which can be shifted by means of a hydraulic or pneumatic drive 76′.

Plate 72′ consists of two pairs of angular sub-channels, where each pair is joined to the inlet sub-channels 23.1, 23.2, respectively. The central inlet channel 71′ is arranged within plate 74′, which is located opposite of it. Slider element 73′ consists of a central recess 75′, which is rectangular in the sectional view according to FIG. 5 and which allows for different switching positions. In a top view onto inlet channel 71′, the recess would have the shape of a horizontal eight. The three parallel, slot-shaped channels, which are connected via common areas on the plate surfaces, enable a deliberate connection of the paired slot channels which jointly lead into one inlet channel. Backflush bore holes 77′ in slider element 73′ enable a backflush of the filter insert by means of a flow reversal and the discharge of the melt cake towards the outside of the housing.

The upper switching valve 60′ is constructed in the same way, but without any backflush bore holes.

The most important switching positions of the double filtering device 100′ are depicted in the sectional views according to FIGS. 6a to 6d, whereby the outlet valve 60′ is always depicted on the left and the inlet valve 70′ on the right.

In the position according to FIG. 6a, the right partial filtering device is fed by establishing a flow path from inlet channel 71′ towards the right sub-channel 23.1. The same can be said for the switching valve at outlet channel 61′ which is depicted on the left: A connection to the left outlet sub-channel 26.2 is established via recess 65′ inside of the slider element, which is connected to the right filter chamber 24.

In the position according to FIG. 6b, both sub-channels 23.1, 23.2 at switching valve 70′ are fed from inlet channel 71′, and at switching valve 60′, both sub-channels 26.1, 26.2 are connected to outlet channel 61′. This position shows the parallel operation of both partial filtering devices, or it depicts the moment, when one partial filtering device is switched to the other partial filtering device.

The position according to FIG. 6c only allows a supply to the left inlet sub-channel 23.2 at switching valve 70′ on the inlet side, and thus results in the operation of only the left partial filtering device. Also at switching valve 60′ on the outlet side, only the left partial filtering device is connected to outlet channel 61′ via the left outlet sub-channel 26.2.

In the position according to FIG. 6d, the backflush for the filter insert in the right filter chamber 24 is performed while the production is maintained via the filter insert in the left filter chamber 24′. The melt flows from inlet channel 71′ via switching valve 70 into the left inlet sub-channel 23.2 and via the left filter chamber 24 towards the slider element of the upper switching valve 60′, which leads to outlet channel 61′. Slider element 63′ is positioned in such a way, that its recess 65′ is connected to both outlet sub-channels 26.1, 26.2 at the same time, by means of the respective inner one of the two slot channels which strut apart in V-shape, which both form the outlet channels 26.1, 26.2 and which can be seen in the exemplified switching valve 70′ in FIG. 5.

With the main flow direction through the left filter chamber 24′, there is a connection of the recess 65′ inside of slider element 63′ to the right filter chamber 24, so that the melt does not only stream directly to the outlet channel 61′, but that a transverse flow towards sub-channel 26.1 is formed as well. This flow runs opposite to the common flow direction in production operation through filter chamber 24 according to FIG. 6a and runs through the filter insert which is located there into the right inlet channel 23.1.

At the lower switching valve 70′, the melt can be discharged along with the removed dirt from the filter insert via the outer one of the two slot channels of inlet sub-channel 23.1 into the backflush bore hole 77′ and through it towards the outside of switching valve 70′.

1. Filtering device for the large-area filtration of fluids, in particular of polymer melts, which consists of at least:
a housing with at least one inlet channel and at least one outlet channel and
a filter carrier element which can be moved longitudinally in relation to a housing bore consisting of at least one filter insert, which is to be allocated in a filter chamber that is located between the inlet channel and the outlet channel of the housing in a production position,
wherein the filter insert has a main element through which the flow can pass, and from which a fluid stream branches off into multiple individual filter elements or into which multiple fluid streams from the individual filter elements are joined,
characterized in that the filter insert is arranged on an end face of the filter carrier element and that the filter chamber is formed by
a housing bore, which extends up to a mouth on an outer side of the housing and into which the filter insert can be pushed by moving the filter carrier element, and
a closure element, which can be placed onto the mouth of the housing bore and/or which can be inserted therein when the filter carrier element is lowered into the housing bore or connected to it.

2. Filtering device according to claim 1, characterized in that the main element of the filter insert is a support profile, which is aligned parallel to the longitudinal direction and to the moving direction of the filter carrier element.

3. Filtering device according to claim 2, characterized in that the support profile is a centrally arranged axle tube which can be flown through.

4. Filtering device according to claim 1, characterized in that the closure element can be moved together with the filter carrier element by means of the same drive unit.

5. Filtering device according to claim 1, characterized in that the closure element at the filter carrier element consists of at least one radial flow channel which overlaps in production position with a radial flow channel or an inlet- or outlet channel in the housing and which is directed into an axial flow channel, which leads into the flow channel in the main element of the filter insert.

6. Filtering device according to claim 5, characterized in that at least one flow channel leads to the end face opposite to the mouth of the filter chamber.

7. Filtering device according to claim 6, characterized in that the outlet channel in housing is to be brought into connection with the flow channel of the closure element and the inlet channel with the flow channel at the end face of the filter chamber.

8. Filtering device according to claim 1, characterized in that a mechanical cleaning device can be connected to the filter carrier element instead of the filter insert.

9. Filtering device according to claim 1, characterized in that the filtering device consists of at least two filter carrier elements and that inside of the housing, one respective filter chamber is arranged for each filter carrier element, whereby the inlet channel branches off into at least one respective inlet sub-channel of each filter chamber and where at least one respective outlet sub-channel leads out of each filter chamber, which then leads into the outlet channel.

10. Filtering device according to claim 9, characterized in that a respective switching valve is arranged between the junction from the inlet and/or outlet channel into the sub-channels.

11. Filtering device according to claim 10, characterized in that at least one of the switching valves consists of a slider element, which can be shifted with a central recess between two parallel plates, whereby one of the plates consists of a central inlet channel or of a central outlet channel and the other plate consists of at least two inlet sub-channels or outlet sub-channels.

12. Filtering device according to claim 11, characterized in that the slider element consists of at least one backflush bore hole.

13. Filtering device according to claim 1, characterized in that a conical seat is arranged between the mouth of the housing bore and the closure element, in order to seal it.

14. Filtering device according to claim 1, wherein at least one flow channel leads to the end face opposite to the mouth of the filter chamber.
